(19) United States
(12) Patent Application Publication
(10) Pub. No.: US 2025/0391604 A1
(43) Pub. Date: Dec. 25, 2025

(54) ELECTROLYSIS SYSTEM

(71) Applicant: Delta Electronics (Shanghai) CO., LTD., Shanghai (CN)

(72) Inventors: Yu ZHANG, Shanghai (CN); Shuzhu SU, Shanghai (CN); Qibin TANG, Shanghai (CN); Weiqiang ZHANG, Shanghai (CN)

(73) Assignee: Delta Electronics (Shanghai) CO., LTD., Shanghai (CN)

(21) Appl. No.: 19/245,254

(22) Filed: Jun. 21, 2025

(30) Foreign Application Priority Data
Jun. 21, 2024 (CN) 2024108169308

(51) Int. Cl. H01F 38/14; C25B 9/65; C25B 9/70

(52) U.S. Cl. CPC H01F 38/14; C25B 9/65; C25B 9/70

(57) ABSTRACT

The present disclosure provides an electrolysis system, and relates to the technical field of electrolysis. The electrolysis system includes a first electrolytic cell and a first SST device, the first SST device includes a first input end and a first output end, and the first output end includes a first positive output terminal and a first negative output terminal. The first positive output terminal of the first SST device is electrically connected to a metal electrode of the first electrolytic cell, and the first negative output terminal of the first SST device is electrically connected to an electrolyte of the first electrolytic cell.

### CROSS REFERENCE

This application is based upon and claims priority to Chinese Patent Application No. 2024108169308, filed on Jun. 21, 2024, the entire contents thereof are incorporated herein by reference.

### TECHNICAL FIELD

The present disclosure relates to the technical field of electrolysis, in particular, to an electrolysis system.

### BACKGROUND

In the technical field of electrolysis, a multi-stage voltage step-by-step electrolysis system (for example, a formation system) is required, and the adopted electrolysis system is usually based on a multi-winding transformer to achieve adjustable multi-level voltages. The oil-immersed design is adopted, the low-voltage side outputs are respectively connected to a plurality of low-voltage conversion power supplies, and each low-voltage conversion power supply supplies power to one electrolysis device.

However, the adjustable multi-winding transformer has large volume, heavy weight, significant space occupation, and high installation difficulty. Furthermore, the number of the adjustable tap positions of the transformer winding is limited, making it difficult to accurately match the voltage requirements of various specifications. In addition, existing production lines with multiple power supplies cannot be expanded and require replacing the transformer or increasing the number of secondary output windings for adjustment.

It should be noted that the information disclosed in the foregoing background section is merely intended to enhance understanding of the background of the present disclosure, and therefore may include information that does not constitute the prior art known to those skilled in the art.

### SUMMARY

The present disclosure provides an electrolysis system.

According to an aspect of the present disclosure, there is provided an electrolysis system, including: a first electrolytic cell; and a first solid state transformer (SST) device including a first input end and a first output end, where the first output end includes a first positive output terminal and a first negative output terminal; where the first positive output terminal of the first SST device is electrically connected to an electrolyte of the first electrolytic cell, and the first negative output terminal of the first SST device is electrically connected to the electrolyte of the first electrolytic cell.

According to another aspect of the present disclosure, there is provided an electrolysis system, including: a first electrolytic cell, a second electrolytic cell; and a first solid state transformer (SST) device, including a first input end and a first output end, where the first output end of the first SST device includes a first positive output terminal and a first negative output terminal; where the first positive output terminal of the first SST device is electrically connected to an electrolyte of the first electrolytic cell, the first negative output terminal of the first SST device is electrically connected to an electrolyte of the second electrolytic cell, and the first electrolytic cell is electrically connected to the second electrolytic cell.

It should be understood that the above general description and the following detailed description are exemplary and explanatory only and are not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the specification, serve to explain the principles of the present disclosure. Obviously, the drawings in the following description are only some embodiments of the present disclosure, and for those of ordinary skill in the art, other drawings may be obtained according to these drawings without creative work.

FIG. 1 is a schematic diagram of an electrolysis system according to an embodiment of the present disclosure;

FIG. 1A is a schematic diagram of an electrolysis system according to another embodiment of the present disclosure;

FIG. 1B is a schematic diagram of an electrolysis system according to still another embodiment of the present disclosure;

FIG. 1C is a schematic diagram of an electrolysis system according to yet another embodiment of the present disclosure;

FIG. 2 is a schematic diagram of an electrolysis system according to yet another embodiment of the present disclosure;

FIG. 2A is a schematic diagram of an electrolysis system according to yet another embodiment of the present disclosure;

FIG. 2B is a schematic diagram of an electrolysis system according to yet another embodiment of the present disclosure;

FIG. 3 is a schematic diagram of an electrolysis system according to yet another embodiment of the present disclosure;

FIG. 3A is a schematic diagram of an electrolysis system according to yet another embodiment of the present disclosure;

FIG. 3B is a schematic diagram of an electrolysis system according to yet another embodiment of the present disclosure;

FIG. 4 is a schematic diagram of an electrolysis system according to yet another embodiment of the present disclosure;

FIG. 4A is a schematic diagram of an electrolysis system according to yet another embodiment of the present disclosure;

FIG. 5 is a schematic diagram of an electrolysis system according to yet another embodiment of the present disclosure;

FIG. 5A is a schematic diagram of an electrolysis system according to yet another embodiment of the present disclosure;

FIG. 6 is a schematic structural diagram of a first SST device according to an embodiment of the present disclosure;

FIG. 7 is a schematic structural diagram of a first SST device according to another embodiment of the present disclosure;

FIG. 8 is a schematic structural diagram of a first SST device according to still another embodiment of the present disclosure;

FIG. 9 is a schematic structural diagram of a second SST device according to an embodiment of the present disclosure;

FIG. 10 is a schematic diagram of an electrolysis system according to yet another embodiment of the present disclosure;

FIG. 10A is a schematic diagram of an electrolysis system according to yet another embodiment of the present disclosure;

FIG. 10B is a schematic diagram of an electrolysis system according to yet another embodiment of the present disclosure;

FIG. 11 is a schematic diagram of an electrolysis system according to yet another embodiment of the present disclosure;

FIG. 12 is a schematic diagram of an electrolysis system according to yet another embodiment of the present disclosure;

FIG. 12A is a schematic diagram of an electrolysis system according to yet another embodiment of the present disclosure;

FIG. 12B is a schematic diagram of an electrolysis system according to yet another embodiment of the present disclosure.

### DETAILED DESCRIPTION

Example embodiments will now be described more fully with reference to the accompanying drawings. However, the example embodiments can be embodied in a variety of forms and should not be construed as limited to the implementations set forth herein; rather, these implementations are provided so that the present disclosure will be thorough and complete and fully convey the concepts of the example embodiments to those skilled in the art. The same reference signs in the drawings refer to the same or similar structures, and detailed description thereof will be omitted. In addition, the drawings are merely schematic illustrations of the present disclosure and are not necessarily drawn to scale.

Although relative terms such as “on” and “below” are used in this specification to describe the relative relationship between one component and another component illustrated in the drawings, these terms are used in this specification merely for convenience, for example, according to the orientation of the examples described in the drawings. It can be understood that if the device illustrated in the drawings is turned upside down, the component described as “on” will become the component “below”. When a certain structure is “on” other structure, it may mean that the certain structure is integrally formed on the other structure, or that the certain structure is “directly” disposed on the other structure, or that the certain structure is “indirectly” disposed on the other structure through another structure.

The terms “one”, “a/an”, “the”, “said” and “at least one” are used to indicate that there are one or more elements/components/etc.; the terms “including” and “having” are used to refer to an open-ended inclusion and refer to that there may be additional elements/components/etc., in addition to the listed elements/components/etc.; the terms “first” “second” and “third” and the like are used only as labels, not to the number of objects thereof.

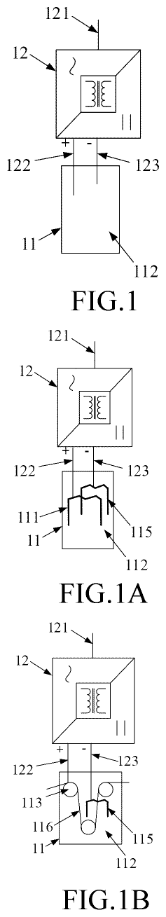

An embodiment of the present disclosure provides an electrolysis system. As shown in FIG. 1, the electrolysis system includes a first electrolytic cell 11 and a first solid state transformer (SST) device 12.

The first SST device 12 includes a first input end 121 and a first output end, and the first output end may include a first positive output terminal 122 and a first negative output terminal 123. The first positive output terminal 122 of the first SST device 12 is electrically connected to an electrolyte 112 of the first electrolytic cell 11, and the first negative output terminal 123 of the first SST device 12 is electrically connected to the electrolyte 112 of the first electrolytic cell 11.

In one embodiment, as shown in FIG. 1A, on the basis of the electrolysis system shown in FIG. 1, the first positive output terminal 122 of the first SST device 12 is electrically connected to a metal electrode 111 of the first electrolytic cell 11, and the first negative output terminal 123 of the first SST device 12 is electrically connected to the electrolyte 112 of the first electrolytic cell 11.

The first electrolytic cell 11 may be provided with the electrolyte 112. The first negative output terminal 123 may be electrically connected to the electrolyte 112 of the first electrolytic cell 11 through a negative metal electrode 115, or may be directly inserted into the electrolyte 112, or may use other ways of being electrically connected to the electrolyte. The metal electrode 111 and the negative metal electrode 115 are electrically connected through the electrolyte 112.

In addition, the first positive output terminal 122 of the first SST device 12 may also be directly inserted into the electrolyte 112 of the first electrolytic cell 11.

In one embodiment, the metal electrode 111 and the negative metal electrode 115 may be extension portions, which may be metal strips, or metal frames, or metal plates.

The positive and negative output terminals may be locked and adhered by the extension portion, and the conductive area between the electrode and the electrolyte may also be enlarged through the extension portion, thereby improving the electrolysis efficiency, etc. The extension portion in the following also has the corresponding effects, which will not be repeated here.

It should also be noted that the positional relationship and sizes of the metal electrode 111 and the negative metal electrode 115 in FIG. 1A are merely exemplary, and the specific position and size relationship of the metal electrodes in the electrolytic cell may be configured according to actual needs. The sizes and positions of the metal electrodes in other figures below are merely exemplary, and may be configured according to actual needs, which will not be described in detail subsequently.

The SST device is a high-frequency transformer equipment integrating power electronics conversion, and there is a power electronics circuit inside. Therefore, the SST device can be used for power conversion, voltage regulation, power factor correction, power quality improvement, and intelligent control, etc. The conventional transformer does not have these functions.

For example, the SST device can convert the input power (alternating current or direct current) into the required output voltage (e.g., an alternating current is converted into a direct current, a direct current is converted into an alternating current, a direct current is converted into a direct current, or an alternating current is converted into an alternating current) and frequency, so as to realize effective conversion and transmission of electric energy. For another example, the SST device can accurately adjust the voltage to ensure stable power output, and meet the requirements of different electrolysis systems on the voltage. For another example, the SST device can improve the power factor of the power system and improve the efficiency and stability of the electrolysis system. For another example, the SST device can filter harmonics and interference in the power, improve power quality, and protect various equipment in the electrolysis system from damage. For another example, the SST device can realize remote monitoring, fault diagnosis and automatic regulation, and improve the operation efficiency and reliability of the electrolysis system.

The use of the first SST device in the electrolysis system instead of the conventional multi-winding transformer can make the electrolysis system have a smaller volume and occupied space, lighter weight, and reduced installation difficulty of the electrolysis system. In addition, the output of the SST device is flexibly adjustable, which makes it easier to meet the requirements of different output voltages and output currents. Moreover, the SST device is easy to expand, and can better adapt to the electrolysis system that needs to change the number of the electrolytic cells.

It should be noted that the first SST device 12 includes one output end, which is merely exemplary. As required, the first SST device may further include two, three, or any number of output ends. In addition, the electrolysis system shown in FIG. 1A includes one SST device and one electrolytic cell, which are merely exemplary, and the electrolysis system may include any number of SST devices and electrolytic cells as needed.

It should also be noted that, if the electrolysis system includes a plurality of SST devices, the input ends of any two SST devices in the plurality of SST devices may be connected to the same power supply in parallel, or may be connected to different power supplies, which is not limited in the embodiments of the present disclosure.

In one embodiment, the first electrolytic cell 11 in the electrolysis system corresponding to FIG. 1A is a formation tank. In this case, the electrolysis system may be as shown in FIG. 1B. In FIG. 1B, the first positive output terminal 122 is electrically connected to a formation foil 116 through a power supply roller 113. The formation foil 116 is a material (e.g., an aluminum foil, a copper foil, and the like) that needs to be formed in the first electrolytic cell 11. The first negative output terminal 123 may be electrically connected to the electrolyte 112 of the first electrolytic cell 11 through the negative metal electrode 115. In this case, the power supply roller 113 is a metal electrode electrically connected to the first positive output terminal 122 in the first electrolytic cell 11.

It should be noted that the first positive output terminal 122 in FIG. 1B being electrically connected to the formation foil 116 through the power supply roller 113 is merely exemplarily. According to the requirement of the electrolysis system, other roller(s) outside the first electrolytic cell 11 that transfers the formation foil 116 may also be used as the power supply roller to achieve that the first positive output terminal 122 is electrically connected to the formation foil 116.

For example, as shown in FIG. 1C, the first positive output terminal 122 is electrically connected to the metal electrode 111 through the power supply roller 114.

In addition, the first positive output terminal 122 may also be electrically connected to the metal electrode 111 through other roller(s) other than the power supply roller 113 in the first electrolytic cell 11, which is not limited in the embodiments of the present disclosure.

When explaining the electrical connection between the output terminal of the SST device and the formation foil through the metal electrode, an example in which the output terminal is electrically connected to the formation foil through the power supply roller in the formation tank is taken for description, but the manner in which the output terminal of the SST device is electrically connected to the formation foil is not limited thereto, and details are not described herein again.

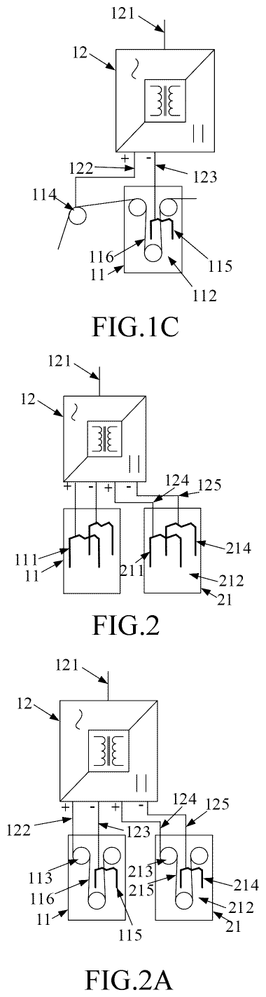

In one embodiment, as shown in FIG. 2, on the basis of the electrolysis system shown in FIG. 1A, the electrolysis system may further include a fourth electrolytic cell 21, and the first SST device 12 may further include a second output end. The second output end of the first SST device 12 may include a second positive output terminal 124 and a second negative output terminal 125, the second positive output terminal 124 of the first SST device 12 is electrically connected to a metal electrode 211 of the fourth electrolytic cell 21, and the second negative output terminal 125 of the first SST device 12 is electrically connected to an electrolyte 212 of the fourth electrolytic cell 21. The ways for the second negative output terminal 125 to be electrically connected to the electrolyte 212 of the fourth electrolytic cell 21 may be: electrically connecting the second negative output terminal 125 to the electrolyte 212 of the fourth electrolytic cell 21 through a metal electrode 214, or directly inserting the second negative output terminal 125 into the electrolyte 212, or other means of electrical connection to the electrolyte. The metal positive electrode 211 and the metal negative electrode 214 may be extension portions.

The fourth electrolytic cell 21 may be provided with the electrolyte 212.

In the electrolysis system, one SST device is provided with two output ends, so that the number of the SST device in the electrolysis system can be reduced, the cost required for preparing the electrolysis system can be reduced, the increase of volume and weight of the electrolysis system caused by the addition of the SST device can be avoided, and the occupied space is saved.

In addition, in the electrolysis system, one SST is provided with two output ends, so that the waste of the capacity of the SST device (the capacity of the output power, i.e., the capacity of the power that can be processed and converted) can be avoided, and the utilization rate of the capacity of the SST device is increased.

In one embodiment, the first electrolytic cell 11 and/or the fourth electrolytic cell 21 in the electrolysis system corresponding to FIG. 2 is a formation tank.

Taking the first electrolytic cell 11 and the fourth electrolytic cell 21 being the formation tanks as an example, in this case, the electrolysis system may be as shown in FIG. 2A. In FIG. 2A, the first positive output terminal 122 is electrically connected to the formation foil 116 through the power supply roller 113, and in this case, the power supply roller 113 is a metal electrode electrically connected to the first positive output terminal 122 in the first electrolytic cell 11. The second positive output terminal 124 is electrically connected to the formation foil 215 through a power supply roller 213. In this case, the power supply roller 213 is a metal electrode electrically connected to the second positive output terminal 124 in the fourth electrolytic cell 21.

In FIG. 2A, the way of the first negative output terminal 123 being electrically connected to the electrolyte 112 of the first electrolytic cell 11 may be an electrical connection to the electrolyte 112 of the first electrolytic cell 11 through the negative metal electrode 115. The way of the second negative output terminal 125 being electrically connected to the electrolyte 212 of the fourth electrolytic cell 21 may be an electrical connection to the electrolyte 212 of the fourth electrolytic cell 21 through the metal electrode 214.

When both the first electrolytic cell 11 and the fourth electrolytic cell 21 are formation tanks, the first electrolytic cell 11 and the fourth electrolytic cell 21 may be adjacent two-stage formation tanks, or may not be adjacent two-stage formation tanks, which is not limited in the embodiments of the present disclosure.

The metal electrodes (power supply rollers) of the two formation tanks are connected by a formation material. As shown in FIG. 2B, the power supply rollers of the first electrolytic cell 11 and the fourth electrolytic cell 21 are electrically connected to each other through the same continuous formation foil. It should be noted that, FIG. 2B is drawn by using an example in which the first electrolytic cell 11 and the fourth electrolytic cell 21 are two adjacent two-stage formation tanks.

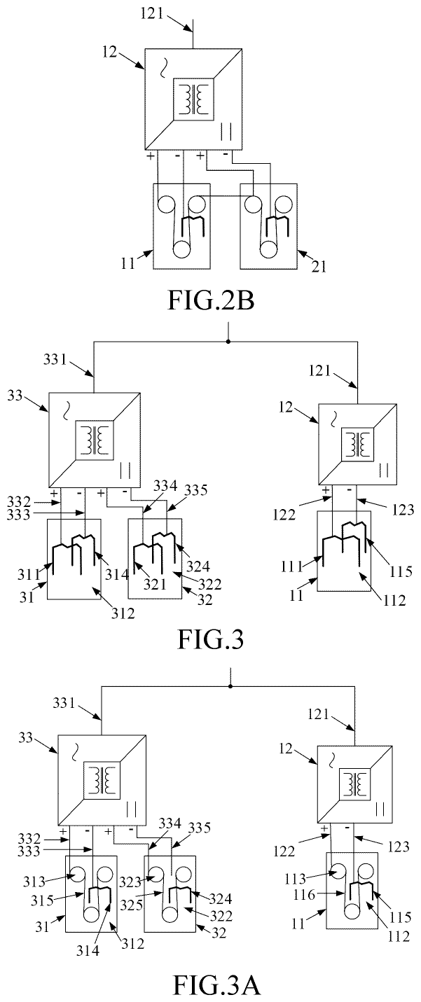

In another embodiment, as shown in FIG. 3, on the basis of the electrolysis system shown in FIG. 1A, the electrolysis system may further include a second electrolytic cell 31, a third electrolytic cell 32 and a second SST device 33, where the second SST device 33 includes a first input end 331, a first output end and a second output end. The first output end of the second SST device 33 may include a first positive output terminal 332 and a first negative output terminal 333. The second output end of the second SST device 33 may include a second positive output terminal 334 and a second negative output terminal 335. The first input end 121 of the first SST device 12 is connected in parallel with the first input end 331 of the second SST device 33, and the first positive output terminal 332 of the second SST device 33 is electrically connected to a metal electrode 311 of the second electrolytic cell 31. The first negative output terminal 333 of the second SST device 33 is electrically connected to an electrolyte 312 of the second electrolytic cell 31, the second positive output terminal 334 of the second SST device 33 is electrically connected to a metal electrode 321 of the third electrolytic cell 32, and the second negative output terminal 335 of the second SST device 33 is electrically connected to an electrolyte 322 of the third electrolytic cell 32.

As shown in FIG. 3, the way of the first negative output terminal 333 being electrically connected to the electrolyte 312 of the second electrolytic cell 31 may be an electrical connection to the electrolyte 312 of the second electrolytic cell 31 through a metal electrode 314. The way of the second negative output terminal 335 being electrically connected to the electrolyte 322 of the third electrolytic cell 32 may be an electrical connection to the electrolyte 312 of the second electrolytic cell 31 through a metal electrode 324.

In FIG. 3, the metal electrode 311, the metal electrode 321, the metal electrode 314 and the metal electrode 324 may all be extension portions.

It should be noted that the second SST device 33 includes two output ends, which is merely exemplary, and the second SST device 33 may further include one, two, three, and other numbers of the output ends, as needed. In addition, the electrolysis system shown in FIG. 3 includes two SST devices and three electrolytic cells, which is also merely exemplary, and the electrolysis system may include any number of SST devices and electrolytic cells as needed.

In one embodiment, the voltages output by the two output ends of the second SST device 33 may be the same or different, that is, the voltages output by the first output end and the second output end of the second SST device 33 may be the same or different, which is not limited in the embodiments of the present disclosure. The magnitude of the output voltage of the first output end and the second output end of the second SST device 33 may be configured according to the needs of the electrolysis system.

In the electrolysis system, the number of SST devices and the number of output ends of each SST device are flexibly matched, the capacity of the SST device and the corresponding output voltage can be better utilized, and the requirements of each stage of the electrolytic cell on the input voltage can be better met.

In one embodiment, at least one of the first electrolytic cell 11, the second electrolytic cell 31 and the third electrolytic cell 32 in the electrolysis system corresponding to FIG. 3 is a formation tank or a hydrogen production electrolytic cell.

In one embodiment, at least one of the first electrolytic cell 11, the second electrolytic cell 31 and the third electrolytic cell 32 in the electrolysis system corresponding to FIG. 3 is a formation tank, and the remaining tank(s) is a hydrogen production electrolytic cell.

Taking the first electrolytic cell 11, the second electrolytic cell 31 and the third electrolytic cell 32 all being formation tanks as an example, in this case, the electrolysis system may be as shown in FIG. 3A. In FIG. 3A, the first positive output terminal 122 of the first SST device 12 is electrically connected to the formation foil 116 through the power supply roller 113, and in this case, the power supply roller 113 is a metal electrode electrically connected to the first positive output terminal 122 in the first electrolytic cell 11. The first positive output terminal 332 of the second SST device 33 is electrically connected to the formation foil 315 through a power supply roller 313. In this case, the power supply roller 313 is a metal electrode electrically connected to the first positive output terminal 332 in the second electrolytic cell 31. The second positive output terminal 334 of the second SST device 33 is electrically connected to the formation foil 325 through a power supply roller 323. In this case, the power supply roller 323 is a metal electrode electrically connected to the second positive output terminal 334 in the third electrolytic cell 32.

It should be noted that, when the first electrolytic cell 11, the second electrolytic cell 31 and the third electrolytic cell 32 are all formation tanks, any two electrolytic cells among the first electrolytic cell 11, the second electrolytic cell 31 and the third electrolytic cell 32 may be adjacent two-stage formation tanks, or may not be adjacent two-stage formation tanks, which is not limited in the embodiments of the present disclosure.

The metal electrodes (power supply rollers) of the three formation tanks are connected through a formation material 315. As shown in FIG. 3B, the power supply rollers of the first electrolytic cell 11, the second electrolytic cell 31 and the third electrolytic cell 32 are electrically connected to each other through the same continuous formation foil 315. It should be noted that, FIG. 3B is drawn by using an example in which the first electrolytic cell 11, the second electrolytic cell 31 and the third electrolytic cell 32 are adjacent three-stage formation tanks.

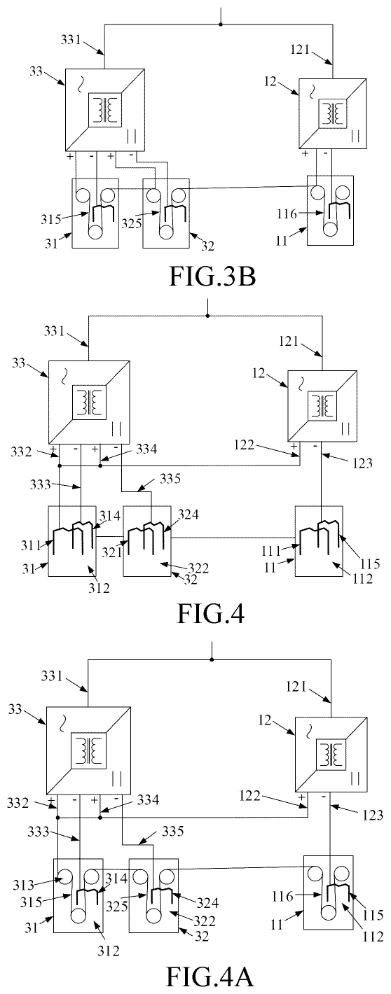

In one embodiment, as shown in FIG. 4, on the basis of the electrolysis system shown in FIG. 3, the first positive output terminal 122 of the first SST device 12, the first positive output terminal 332 of the second SST device 33, and the second positive output terminal 334 of the second SST device 33 are electrically connected; and the metal electrode 311 of the second electrolytic cell 31, the metal electrode 321 of the third electrolytic cell 32, and the metal electrode 111 of the first electrolytic cell 11 are electrically connected.

A manner in which the metal electrode 311 of the second electrolytic cell 31, the metal electrode 321 of the third electrolytic cell 32 and the metal electrode 111 of the first electrolytic cell 11 are electrically connected may be that the metal electrode 311 is electrically connected to the second electrolytic cell 31 through an electrolyte 312, the second electrolytic cell 31 is electrically connected to the third electrolytic cell 32, and then is electrically connected to the metal electrode 321 through an electrolyte 322, and the third electrolytic cell 32 is electrically connected to the first electrolytic cell 11, and then is electrically connected to the metal electrode 111 through an electrolyte 112, so that the metal electrode 311 of the second electrolytic cell 31, the metal electrode 321 of the third electrolytic cell 32, and the metal electrode 111 of the first electrolytic cell 11 are electrically connected.

A manner of the second electrolytic cell 31 being electrically connected to the third electrolytic cell 32, and a manner of the third electrolytic cell 32 being electrically connected to the first electrolytic cell 11 may be an electrical connection realized by a conductive medium (e.g., a metal conductive device), or may be that a pipeline is provided between the two electrolytic cells, and the electrolyte between the two electrolytic cells is intercommunicated, to achieve the electrical connection through the electrolyte. The electrical connection between the two electrolytic cells may be achieved through a conductive medium, or by configuring a pipeline to achieve electrical connection through the electrolyte, which will not be described in detail subsequently.

As shown in FIG. 4, the first negative output terminal 333 of the second SST device 33 is electrically connected to the metal electrode 314, the first negative output terminal 335 of the second SST device 33 is electrically connected to the metal electrode 324, and the first negative output terminal 123 of the first SST device 12 is electrically connected to the negative metal electrode 115.

In the electrolysis system, the positive output terminals of the output ends of individual SST devices may be electrically connected, and the metal electrodes of individual electrolytic cells may be electrically connected.

The positive output terminals of a plurality of output ends of one SST device may also be electrically connected. The metal electrodes of the electrolytic cells electrically connected to the output ends of the SST device may also be directly electrically connected.

In one embodiment, at least one of the first electrolytic cell 11, the second electrolytic cell 31, and the third electrolytic cell 32 in the electrolysis system corresponding to FIG. 4 is a formation tank.

Taking the first electrolytic cell 11, the second electrolytic cell 31 and the third electrolytic cell 32 all being formation tanks as an example, in this case, the electrolysis system may be shown in FIG. 4A. In FIG. 4A, after the first positive output terminal 122 of the first SST device 12, the first positive output terminal 332 of the second SST device 33, and the second positive output terminal 334 of the second SST device 33 are electrically connected, the obtained output terminal is electrically connected to a formation foil 315 through the power supply roll 313, and in this case, the power supply roll 313 is a metal electrode electrically connected to the positive output terminal in the second electrolytic cell 31.

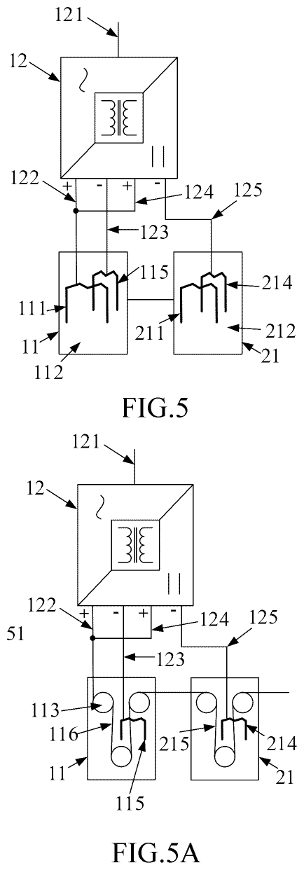

In one embodiment, as shown in FIG. 5, on the basis of the electrolysis system shown in FIG. 2, the first positive output terminal 122 of the first SST device 12 is electrically connected to the second positive output terminal 124 of the first SST device 12, and the metal electrode 111 of the first electrolytic cell 11 is electrically connected to the metal electrode 211 of the fourth electrolytic cell 21.

A manner in which the metal electrode 111 of the first electrolytic cell 11 is electrically connected to the metal electrode 211 of the fourth electrolytic cell 21 may be that the metal electrode 111 is electrically connected to the first electrolytic cell 11 through an electrolyte 112, the first electrolytic cell 11 is electrically connected to the fourth electrolytic cell 21, and then is electrically connected to the metal electrode 214 through an electrolyte 212.

In one embodiment, the first electrolytic cell 11 and/or the fourth electrolytic cell 21 in the electrolysis system corresponding to FIG. 5 is a formation tank.

Taking the first electrolytic cell 11 and the fourth electrolytic cell 21 being formation tanks as an example, the electrolysis system may be as shown in FIG. 5A. In FIG. 5A, the first positive output terminal 122 is electrically connected to the second positive output terminal 124 and then electrically connected to a formation foil 116 through the power supply roller 113, and in this case, the power supply roller 113 is a metal electrode electrically connected to the first positive output terminal 122 in the first electrolytic cell 11.

The formation foil 116 and the formation foil 215 belong to the same continuous formation foil.

In one embodiment, the number of output ends of the first SST device 12 and the number of output ends of the second SST device 33 are different, and the number of electrolytic cells electrically connected to the output ends of the first SST device 12 and the number of electrolytic cells electrically connected to the output ends of the second SST device 33 are different.

The embodiments of the present disclosure do not limit the specific numbers of the output ends of the first SST device 12 and the second SST device 33 respectively.

The number of the output ends of the first SST device 12 may be less than that of the second SST device 33. For example, the number of the output ends of the first SST device 12 is 1, and the number of the output ends of the second SST device 33 is 2.

The number of the output ends of the first SST device 12 may be greater than the number of the output ends of the second SST device 33, for example, the number of the output ends of the first SST device 12 is 4, and the number of the output ends of the second SST device 33 is 2.

The embodiments of the present disclosure do not limit the specific numbers of the electrolytic cells to which the output ends of the first SST device 12 and the second SST device 33 are electrically connected respectively.

For example, the number of the electrolytic cells 1 electrically connected to the output ends of the first SST device 12 is 1 and the number of the electrolytic cells electrically connected to the output ends of the second SST device 33 is 2. For another example, the number of the electrolytic cells electrically connected to the output ends of the first SST device 12 is 4, and the number of the electrolytic cells electrically connected to the output ends of the second SST device 33 is 2.

It should be noted that the number of the output ends of the SST device is not less than the number of the electrolytic cells electrically connected.

In one embodiment, the first electrolytic cell 11 is a formation tank.

In one embodiment, both the second electrolytic cell 31 and the third electrolytic cell 32 are formation tanks.

The embodiments of the present disclosure do not limit whether the power source electrically connected to the first input end 121 of the first SST device 12 is specifically a direct current (DC) or an alternating current (AC). In one embodiment, the first input end 121 of the first SST device 12 is electrically connected to a medium-voltage alternating current.

In one embodiment, the input ends of the SST devices included in the electrolysis system are connected in parallel and then electrically connected to a power source. The embodiments of the present disclosure do not limit whether the power source specifically outputs a direct current or an alternating current. For example, the power source outputs a medium-voltage alternating current.

Taking the electrolysis system including the first SST device 12 and the second SST device 33 as an example, the first input end 121 of the first SST device 12 and the first input end 331 of the second SST device 33 are connected in parallel, and then electrically connected to the medium-voltage alternating current.

The embodiments of the present disclosure do not limit the specific voltage of the above medium-voltage alternating current. For example, the voltage of the medium-voltage alternating current is 10 KV (kilovolts) or 35 KV (kilovolts).

In the electrolysis system according to the embodiments of the present disclosure, whether the direct/alternating properties of the electrical signals output by different output ends of the same SST device are the same is not limited in the embodiments of the present disclosure. For example, the electrical signals output by two output ends of the same SST device are direct current electrical signals. For another example, the electrical signals output by two output ends of the same SST device are alternating current electrical signals. For another example, one of the electrical signals output by the two output ends of the same SST device is an alternating current electrical signal, and the other is a direct current electrical signal.

It should be noted that the electrical signal may be a voltage signal or a current signal.

In one embodiment, in the electrolysis system, the direct/alternating properties of the electrical signals output by the output ends of the same SST device are the same. In this case, the embodiments of the present disclosure do not limit whether the electrical signals output by the output ends of each SST device in the electrolysis system of the embodiments of the present disclosure are specifically alternating current electrical signals or direct current electrical signals. The electrical signals output by the output ends of two different SST devices may both be direct current electrical signals, both be alternating current electrical signals, or one may be a direct current electrical signal and the other may be an alternating current electrical signal.

In one embodiment, the electrical signals output by the output ends of the SST device in the electrolysis system are all direct current electrical signals. For example, the electrical signals output by the output ends of the first SST device 12 and the second SST device 33 are all direct current electrical signals.

In the electrolysis system according to the embodiments of the present disclosure, whether the electrical signals output by different output ends of the same SST device are the same is not limited in the embodiments of the present disclosure. For example, the electrical signals output by the two output ends of the same SST device are the same direct current electrical signal, or are different direct current electrical signals, or are the same alternating current electrical signal, or are different alternating current electrical signals.

In one embodiment, the first output end and the second output end of the first SST device 12 output different DC voltage signals.

In one embodiment, the first output end and the second output end of the second SST device 33 output different DC voltage signals.

The embodiments of the present disclosure do not limit the specific internal structure of the first SST device 12.

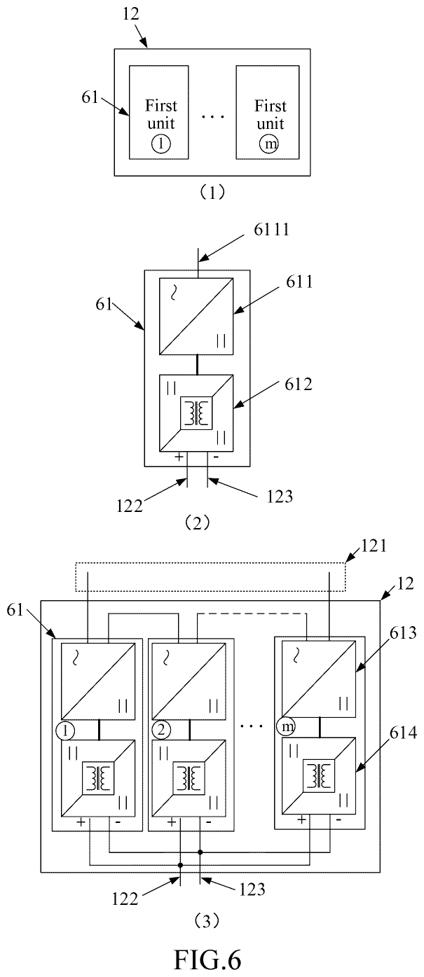

In one embodiment, as shown in (1) in FIG. 6, when the first SST device 12 includes a first output end, the first SST device 12 includes m first units 61, and m is an integer greater than or equal to 1.

When m is 1, as shown in (2) in FIG. 6, the first unit 61 includes an electrically connected first alternating current to direct current (ACDC) module 611 and a first direct current to direct current (DCDC) module 612, an input end 6111 of the first ACDC module 611 forms the first input end 121 of the first SST device 12, and an output end of the first DCDC module 612 forms the first output end of the first SST device 12.

When m is greater than 1, as shown in (3) in FIG. 6, each first unit 61 includes a second ACDC module 613 and a second DCDC module 614. In each first unit, the second ACDC module 613 is electrically connected to the second DCDC module 614, input ends of the m second ACDC modules 613 are connected in series to form the first input end 121 of the first SST device 12, and output ends of the m second DCDC modules 614 are connected in parallel to form the first output end of the first SST device 12.

The ACDC module is used for converting an alternating current into a direct current, and the DCDC module is used for converting a direct current into a direct current with a different voltage level.

The embodiments of the present disclosure do not limit the specific value of m when m is greater than 1. For example, m is equal to 2, or m is equal to 3, and so on.

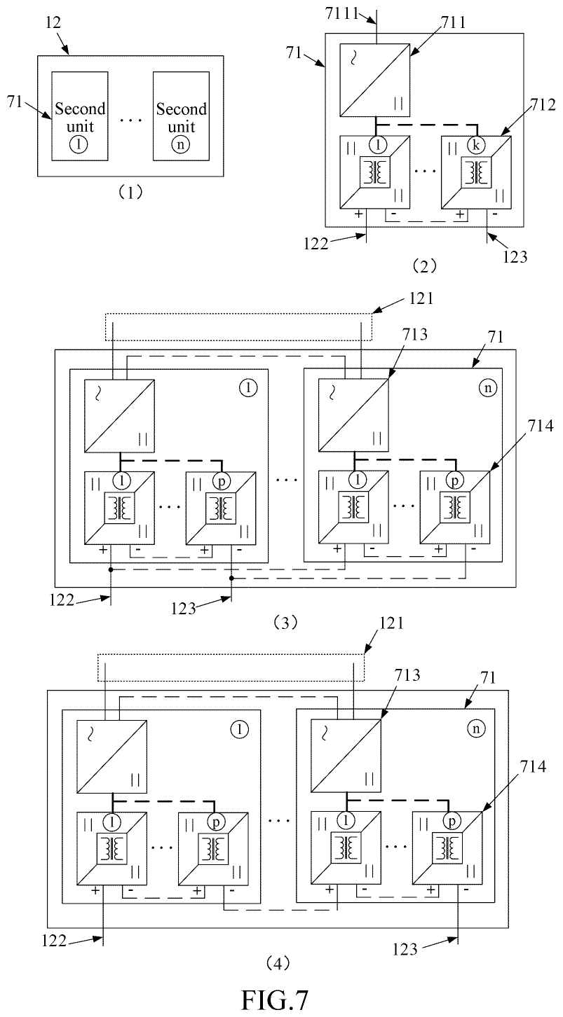

In another embodiment, as shown in (1) in FIG. 7, the first SST device 12 includes n second units 71, and n is an integer greater than or equal to 1.

When n is 1, as shown in (2) in FIG. 7, the second unit 71 includes a third ACDC module 711 and k third DCDC modules 712. k is an integer greater than 1. Input ends of the k third DCDC modules 712 are connected in parallel and then electrically connected to the output end of the third ACDC module 711. An input end 7111 of the third ACDC module 711 forms the first input end 121 of the first SST device 12, and output ends of the k third DCDC modules are connected in series to form the first output end of the first SST device 12.

The embodiments of the present disclosure do not impose any restrictions on the specific value of k. For example, k is equal to 2, or k is equal to 3, and so on.

When n is greater than 1, in one embodiment, as shown in (3) in FIG. 7, each second unit 71 includes a fourth ACDC module 713 and p fourth DCDC modules 714, and p is an integer greater than 1. In each second unit, input ends of the p fourth DCDC modules 714 are connected in parallel and then electrically connected to the output end of the fourth ACDC module 713, an input end of the fourth ACDC module 713 forms the input end of the second unit 71, output ends of the p fourth DCDC modules 714 are connected in series to form the output end of the second unit 71, input ends of the n second units 71 are connected in series to form the first input end 121 of the first SST device 12, and output ends of the n second units 71 are connected in parallel to form the first output end of the first SST device 12.

The embodiments of the present disclosure do not limit the specific value of p. For example, p is equal to 2 or p is equal to 3, and so on. The embodiments of the present disclosure do not limit the specific value of n when n is greater than 1. For example, n is equal to 2 or n is equal to 3, and so on.

When n is greater than 1, in another embodiment, as shown in (4) in FIG. 7, each second unit 71 includes a fourth ACDC module 713 and p fourth DCDC modules 714, and p is an integer greater than 1. In each second unit, input ends of the p fourth DCDC modules 714 are connected in parallel and then electrically connected to the output end of the fourth ACDC module 713, an input end of the fourth ACDC module 713 forms the input end of the second unit 71, output ends of the p fourth DCDC modules 714 are connected in series to form the output end of the second unit 71, input ends of the n second units 71 are connected in series to form the first input end 121 of the first SST device 12, and output ends of the n second units 71 are connected in series to form the first output end of the first SST device 12.

It should be noted that in the structure of the first SST device 12 shown in (4) of FIG. 7, it is merely exemplary that each second unit 71 has the same number of p fourth DCDC modules 714. The embodiments of the present disclosure do not limit whether the numbers of the fourth DCDC modules included in any two second units are the same. In one embodiment, there is at least a pair of second units in the first SST device with different numbers of fourth DCDC modules. For example, one second unit has 5 fourth DCDC modules, and the other second unit has 3 DCDC modules.

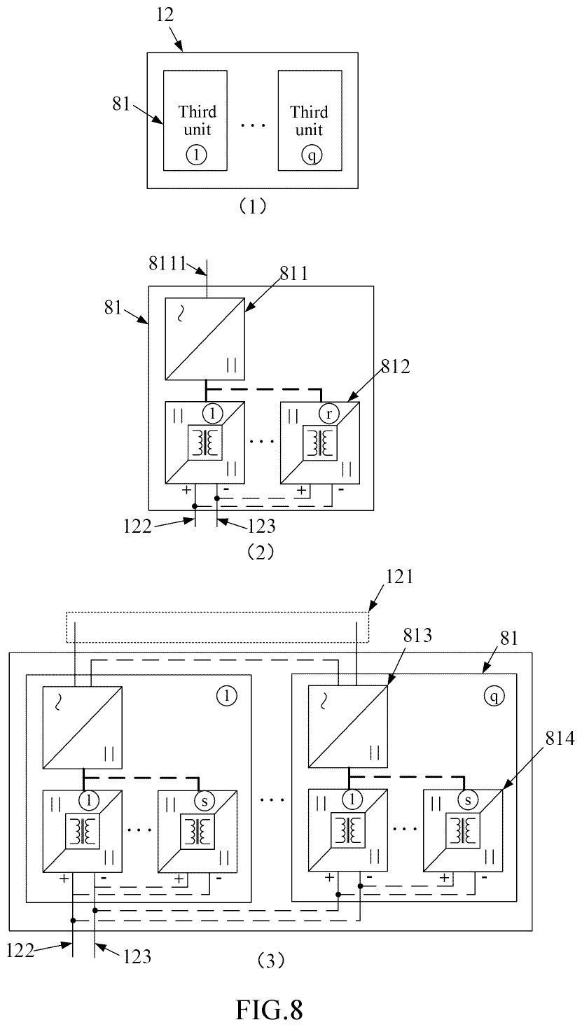

In still another embodiment, as shown in (1) in FIG. 8, the first SST device 12 includes q third units 81, and q is an integer greater than or equal to 1.

When q is 1, as shown in (2) in FIG. 8, the third unit 81 includes a fifth ACDC module 811 and r fifth DCDC modules 812, and r is an integer greater than 1. Input ends of the r fifth DCDC modules 812 are connected in parallel and then electrically connected to the output end of the fifth ACDC module 811, an input end 8111 of the fifth ACDC module 811 forms the first input end 121 of the first SST device 12, and output ends of the r fifth DCDC modules 812 are connected in parallel to form the first output end of the first SST device 12.

The embodiments of the present disclosure do not limit the specific value of r. For example, r is equal to 2, or r is equal to 3, and so on.

When q is greater than 1, as shown in (3) in FIG. 8, each third unit 81 includes a sixth ACDC module 813 and s sixth DCDC modules 814, and s is an integer greater than 1. In each third unit 81, input ends of the s sixth DCDC modules 814 are connected in parallel and then electrically connected to the output end of the sixth ACDC module 813, an input end of the sixth ACDC module 813 forms the input end of the third unit 81, output ends of the s sixth DCDC modules 814 are connected in parallel to form the output end of the third unit 81, input ends of the q third units 81 are connected in series to form the first input end 121 of the first SST device 12, and output ends of the q third units 81 are connected in parallel to form the first output end of the first SST device 12.

The embodiments of the present disclosure do not limit the specific value of q when q is greater than 1. For example, q is equal to 2, or q is equal to 3, and so on. The embodiments of the present disclosure do not limit the specific value of s. For example, s is equal to 2, or s is equal to 3, and so on.

The specific structure of the internal structure of the second SST device 33 is not limited in the embodiments of the present disclosure.

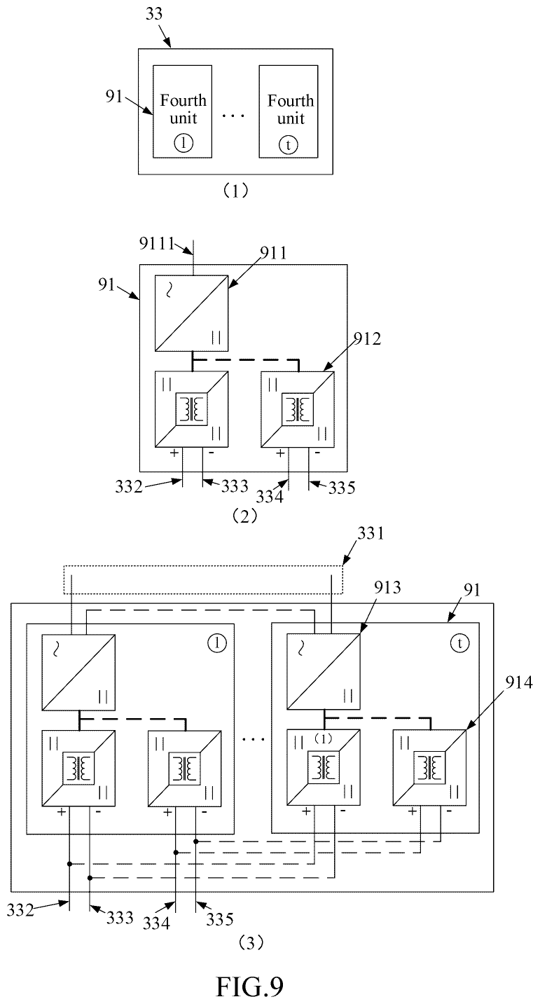

In one embodiment, as shown in (1) in FIG. 9, the second SST device 33 includes t fourth units 91, and/is an integer greater than or equal to 1.

When t is 1, as shown in (2) in FIG. 9, the fourth unit 91 includes a seventh ACDC module 911 and two seventh DCDC modules 912. Input ends of the two seventh DCDC modules 912 are connected in parallel and then electrically connected to the output end of the seventh ACDC module 911, an input end 9111 of the seventh ACDC module 911 forms the first input end 331 of the second SST device 33, and output ends of the two seventh DCDC modules 912 form the first output end and the second output end of the second SST device 33 respectively.

When t is greater than 1, as shown in (3) in FIG. 9, each fourth unit 91 includes an eighth ACDC module 913 and two eighth DCDC modules 914. In each fourth unit 91, input ends of the two eighth DCDC modules 914 are connected in parallel and then electrically connected to the output end of the eighth ACDC module 913, an input end of the eighth ACDC module 913 forms the input end of the fourth unit 91, output ends of the two eighth DCDC modules 914 form the first output end and the second output end of the fourth unit 91 respectively. Input ends of the/fourth units 91 are connected in series to form the first input end 331 of the second SST device 33, first output ends of the/fourth units 91 are connected in parallel to form the first output end of the second SST device 33, and second output ends of the t fourth units 91 are connected in parallel to form the second output end of the second SST device 33.

It should be noted that the second SST device 33 including two output ends is merely exemplary. As needed, the second SST device 33 may have f output ends, where f is an integer greater than or equal to 1. Correspondingly, when the second SST device includes/fourth units, each fourth unit has one ACDC module and f DCDC modules. In each fourth unit, the input ends of the f DCDC modules are connected in parallel and then electrically connected to the output end of the ACDC module. The input end of the ACDC module forms the input end of the fourth unit, and the output ends of the f DCDC modules respectively form the first output end to the f-th output end of the fourth unit. The input ends of the t fourth units are connected in series to form the first input end 331 of the second SST device 33, and the first output ends of the/fourth units are connected in parallel to form the first output end of the second SST device 33. Subsequently, the output ends with the same number in these/fourth units are connected in parallel successively to obtain the f output ends of the second SST device 33.

For example, the second output ends of the t fourth units are connected in parallel to form the second output end of the second SST device 33. For another example, f-th output ends of the/fourth units are connected in parallel to form the f-th output end of the second SST device 33.

In the SST device, configuring multiple DCDC modules in one unit can facilitate the SST device to meet voltage and current requirements of different specifications. In addition, when multiple output ends are needed, this approach can avoid the use of multiple SST devices, thereby reducing costs. Moreover, since multiple output ends are integrated in one SST device, compared with adding an additional SST device to increase output ends, the overall SST device can have a smaller size, resulting in a smaller-volume electrolysis system. When the SST device has multiple units, the output current of the SST device can also be controlled by adjusting the number of parallel-connected units, thus meeting the requirements of the load (e.g., an electrolytic tank).

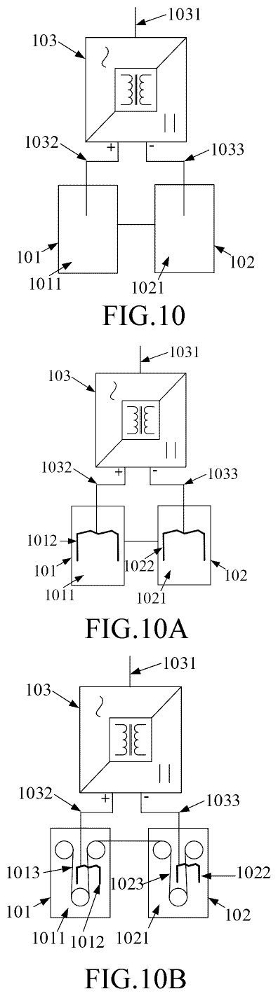

An embodiment of the present disclosure provides an electrolysis system. As shown in FIG. 10, the electrolysis system includes a first electrolytic cell 101, a second electrolytic cell 102, and a first SST device 103.

The first SST device 103 includes a first input end 1031 and a first output end, the first output end of the first SST device 103 includes a first positive output terminal 1032 and a first negative output terminal 1033. The first positive output terminal 1032 of the first SST device 103 is electrically connected to the electrolyte 1011 of the first electrolytic cell 101, the first negative output terminal 1033 of the first SST device 103 is electrically connected to the electrolyte 1021 of the second electrolytic cell 102, and the first electrolytic cell 101 is electrically connected to the second electrolytic cell 102.

In an embodiment, as shown in FIG. 10A, a manner in which the first positive output terminal 1032 is electrically connected to the electrolyte 1011 of the first electrolytic cell 101 may be that the first positive output terminal 1032 is electrically connected to the electrolyte 1011 of the first electrolytic cell 101 through a metal electrode 1012. A manner in which the first negative output terminal 1033 is electrically connected to the electrolyte 1021 of the second electrolytic cell 102 may be that the first negative output terminal 1033 is electrically connected to the electrolyte 1021 of the second electrolytic cell 102 through a metal electrode 1022.

A manner in which the metal electrode 1012 of the first electrolytic cell 101 is electrically connected to the metal electrode 1022 of the second electrolytic cell 102 may be that the metal electrode 1012 is electrically connected to the first electrolytic cell 101 through the electrolyte 1011, the first electrolytic cell 101 is electrically connected to the second electrolytic cell 102, and then is electrically connected to the metal electrode 1022 through the electrolyte 1021.

The metal electrode 1012 and the metal electrode 1022 may both be extension portions.

In one embodiment, a manner of the first electrolytic cell 101 being electrically connected to the second electrolytic cell 102 may be an electrical connection realized by a conductive medium (e.g., a metal conductor), or may be that a pipeline is provided between the first electrolytic cell 101 and the second electrolytic cell 102, so that the electrolyte between the first electrolytic cell 101 and the second electrolytic cell 102 is intercommunicated, thereby realizing the electrical connection between the first electrolytic cell 101 and the second electrolytic cell 102. The electrical connection between different electrolytic cells may be implemented by a conductive medium or a pipeline, which will not be described in detail subsequently.

In the electrolysis system corresponding to FIG. 10, the way in which the first positive output terminal 1032 of the first SST device 103 is electrically connected to the first electrolytic cell 101 and the first negative output terminal 1033 is electrically connected to the second electrolytic cell 102 can reduce the cell voltage during the electrolysis of the powered electrolytic cells, thus saving electrical energy. In addition, powering through the electrolytic cells can also increase the current during the electrolysis process and improve the efficiency during electrolysis. If the electrolysis process is formation, the way of powering through the electrolytic cells can also increase the electrostatic capacitance of the formation foil.

In one embodiment, one of the first electrolytic cell 101 and the second electrolytic cell 102 is a power supply tank, and the other is a formation tank. In this case, the electrolysis system may be as shown in FIG. 10B. In FIG. 10B, the first positive output terminal 1032 is electrically connected to the electrolyte 1011 of the first electrolytic cell 101, the first negative output terminal 1033 is electrically connected to the electrolyte 1021 of the second electrolytic cell 102, and the metal electrode 1012 of the first electrolytic cell 101 is electrically connected to the metal electrode 1022 of the second electrolytic cell 102. The first electrolytic cell 101 and the second electrolytic cell 102 are electrically connected by a formation foil. The first electrolytic cell 101 is electrically connected with the formation foil 1013 through the electrolyte 1011. The formation foil 1013 and the formation foil 1023 are the same continuous formation foil, the formation foil 1013 is electrically connected with the formation foil 1023, and the formation foil 1023 is electrically connected with the second electrolytic cell 102 through the electrolyte 1021.

The area of the formation foil immersed in the first electrolytic cell 101 is larger than the area of the formation foil contacting the roller, so that when power is supplied through the electrolytic cell, the current during formation can be increased, and the formation efficiency can be improved.

If the electrolysis system shown in FIG. 10 is applied in the formation process, the cell voltage during formation of the powered formation tank can be reduced, thereby saving electric energy. In addition, powering by the power supply tank can increase the current during the formation process, raise the formation speed, and thereby improving the production efficiency.

It should be noted that the first SST device 103 in FIG. 10 including only one output end is merely an example. As required, the first SST device 103 may have multiple output ends. For each output end, the positive and negative output terminals thereof may be electrically connected to the electrolytes of different electrolytic cells, and the metal electrodes of the different electrolytic cells are electrically connected, or the positive output terminal of the output end may be electrically connected to the metal electrode of the electrolytic cell, and the negative output terminal may be electrically connected to the electrolyte of the electrolytic cell, which is not limited in the embodiments of the present disclosure.

In addition, the positive output terminals of different output ends may be connected in parallel, and the output terminals connected in parallel may be electrically connected to the metal electrode of the electrolytic cell, or may be electrically connected to the electrolyte of the electrolytic cell.

If the output terminal (hereinafter referred to as a parallel output terminal) obtained by connecting the positive output terminals of different output ends in parallel is electrically connected to a metal electrode of an electrolytic cell, then the negative output terminals of the output ends with the positive output terminals connected in parallel are electrically connected to different electrolytic cells (including the electrolytic cell electrically connected to the parallel output terminal), and the metal electrodes of the different electrolytic cells are connected in series. If the parallel output terminal is electrically connected to the electrolyte of an electrolytic cell, the negative output terminals of the output ends with the positive output terminals connected in parallel are electrically connected to different electrolytic cells (not including the electrolytic cell electrically connected to the parallel output terminal), and the different electrolytic cells and the metal electrode of the electrolytic cell electrically connected to the parallel output terminal are connected in series.

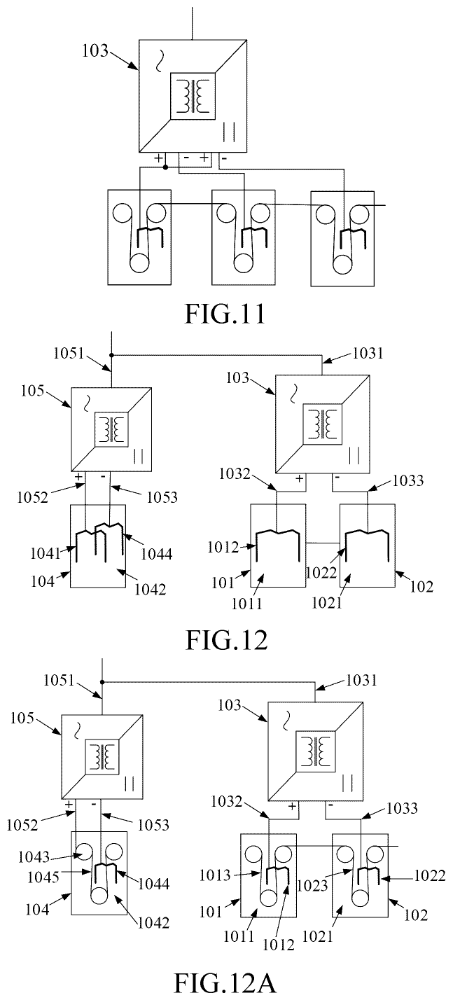

Taking the first SST device 103 including two output ends, and the positive output terminals of the two output ends being connected in parallel and then electrically connected to an electrolyte of an electrolytic cell, and the negative output terminals of the two output ends being electrically connected to the electrolytes of different electrolytic cells respectively as an example, the structure of the electrolysis system may be as shown in FIG. 11. It should be noted that FIG. 11 is drawn by taking the electrolytic cells all being formation tanks or power supply tanks as an example, but the type of the electrolytic cell is not limited thereto.

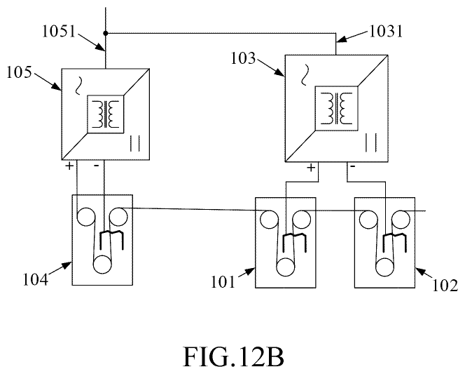

In one embodiment, as shown in FIG. 12, on the basis of the electrolysis system shown in FIG. 10, the electrolysis system further includes a third electrolytic cell 104 and a second SST device 105, where the second SST device 105 includes a first input end 1051 and a first output end, the first input end 1031 of the first SST device 103 is connected in parallel with the first input end 1051 of the second SST device 105, the first output end of the second SST device 105 includes a first positive output terminal 1052 and a first negative output terminal 1053, the first positive output terminal 1052 of the second SST device 105 is electrically connected to a metal electrode 1041 of the third electrolytic cell 104, and the first negative output terminal 1053 of the second SST device 105 is electrically connected to an electrolyte 1042 of the third electrolytic cell 104.

A manner in which the first negative output terminal 1053 is electrically connected to the electrolyte 1042 of the third electrolytic cell 104 may be that the first negative output terminal 1053 is electrically connected to the electrolyte 1042 of the third electrolytic cell 104 through the metal electrode 1044.

In one embodiment, the metal electrode 1041 and the metal electrode 1044 may both be extension portions.

In one embodiment, the third electrolytic cell 104 is a formation tank.

In one embodiment, at least one of the second electrolytic cell 102 and the third electrolytic cell 104 is a formation tank.

Taking the second electrolytic cell 102 and the third electrolytic cell 104 both being formation tanks, and the first electrolytic cell 101 being a power supply tank as an example, in this case, the electrolysis system may be as shown in FIG. 12A. In FIG. 12A, the first positive output terminal 1032 of the first SST device 103 is electrically connected to the electrolyte 1011 of the first electrolytic cell 101, the first negative output terminal 1033 of the first SST device 103 is electrically connected to the electrolyte 1021 of the second electrolytic cell 102, and the first electrolytic cell 101 and the second electrolytic cell 102 are electrically connected through the formation foil.

The first electrolytic cell 101 is electrically connected to the formation foil 1013, the second electrolytic cell 102 is electrically connected to the formation foil 1023, and the formation foil 1013 and the formation foil 1023 belong to the same continuous formation foil, that is, the formation foil 1013 is electrically connected to the formation foil 1023.

A manner in which the first positive output terminal 1032 is electrically connected to the electrolyte 1011 of the first electrolytic cell 101 may be that the first positive output terminal 1032 is electrically connected to the electrolyte 1011 of the first electrolytic cell 101 through the metal electrode 1012. A manner in which the first negative output terminal 1033 is electrically connected to the electrolyte 1021 of the second electrolytic cell 102 may be that the first negative output terminal 1033 is electrically connected to the electrolyte 1021 of the second electrolytic cell 102 through the metal electrode 1022.

The first positive output terminal 1052 of the second SST device 105 is electrically connected to the formation foil 1045 through a power supply roller 1043. In this case, the power supply roller 1043 is a metal electrode electrically connected to the first positive output terminal 1052 in the third electrolytic cell 104.

Taking the third electrolytic cell 104 being a pre-stage formation tank and the second electrolytic cell 102 being a post-stage formation tank as an example, the metal electrodes of the first electrolytic cell 101, the second electrolytic cell 102 and the third electrolytic cell 104 are connected by a formation material. As shown in FIG. 12B, the metal electrodes of the first electrolytic cell 101, the second electrolytic cell 102 and the third electrolytic cell 104 are connected to each other, and all belong to the same continuous aluminum foil (here, the formation material is an aluminum foil for example). It should be noted that FIG. 12B is drawn by taking the second electrolytic cell 102 and the third electrolytic cell 104 as two adjacent two-stage formation tanks as an example.

If the electrolysis system shown in FIG. 12 is applied to formation, and the third electrolytic cell 104 is a pre-stage formation, the electrolysis system can realize the increase of the current during formation of the post-stage formation tank without increasing the current of the pre-stage formation tank during formation, thereby reducing the probability of arcing in the formation material (e.g., aluminum foil).

It should be noted that, in the electrolysis system of FIG. 12, the first SST device 103 and the second SST device 105 each include an output end, which is merely an example, and the first SST device 103 and the second SST device 105 may each have any number of output ends as needed, which is not limited in the present disclosure.

For example, the second SST device 105 has two output ends.

In one embodiment, the number of the output ends of the first SST device 103 and the number of the output ends of the second SST device 105 are different, and the number of the electrolytic cells electrically connected to the output ends of the first SST device 103 and the number of the electrolytic cells electrically connected to the output ends of the second SST device 105 are different.

For example, the first SST device 103 has one output end, and the positive and negative output terminals of the output end are electrically connected to one electrolytic cell respectively. The second SST device 105 has two output ends, but only one of the two output ends is electrically connected to one electrolytic cell, and the other output end is idle or electrically connected to other equipment, etc.

For another example, the first SST device 103 has two output ends, and the positive and negative output terminals of one of the two output ends are electrically connected to one electrolytic cell respectively, and the other output end is electrically connected to one electrolytic cell. The second SST device 105 has one output end, and the output end is electrically connected to one electrolytic cell.

When one output end of the SST device corresponds to one electrolytic cell, and two different SST devices are electrically connected to different number of electrolytic cells, at least one SST device in the two SST devices is electrically connected to a plurality of electrolytic cells, and by configuring a plurality of output ends through one SST device and electrically connecting to a plurality of electrolytic cells, the capacity of the SST device can be fully utilized, the number of SST devices applied in the electrolysis system can be reduced, and the cost and complexity of constructing the electrolysis system can be reduced.

The power supply electrically connected to the first input end 1031 of the first SST device 103 is a direct current or an alternating current, which is not limited in the embodiments of the present disclosure. In one embodiment, the first input end 1031 of the first SST device 103 is electrically connected to a medium-voltage alternating current.

The embodiments of the present disclosure do not limit the specific voltage of the above medium-voltage alternating current. For example, the voltage of this medium-voltage alternating current is 10 kV or 35 kV (kilovolts).

In one embodiment, the input ends of the SST devices included in the electrolysis system are connected in parallel and then electrically connected to a power source. The embodiments of the present disclosure do not limit whether the power source outputs a direct current or an alternating current. For example, the power source outputs a medium-voltage alternating current.

In the electrolysis system according to the embodiments of the present disclosure, the electrical signal output by the SST device (e.g., the first SST device 103 and the second SST device 105) is an alternating current electrical signal or a direct current electrical signal, which is not limited in the embodiments of the present disclosure. The electrical signals output by the output ends of two different SST devices may be both direct current electrical signals or both alternating current electrical signals, or one may be a direct current electrical signal, and the other may be an alternating current electrical signal.

In one embodiment, the electrical signals output by the output ends of the SST device in the electrolysis system are all direct current electrical signals.

For example, the electrical signals output by the output ends of the first SST device 103 and the second SST device 105 are all direct current electrical signals, and the direct current electrical signals may be DC voltage signals or DC current signals.

In one embodiment, the electrical signals output by the output ends of the first SST device 103 and the second SST device 105 are all DC voltage signals.

The direct current voltage signals output by the output ends of the first SST device 103 and the second SST device 105 may be the same or different. In one embodiment, the output ends of the first SST device 103 and the second SST device 105 output different direct current voltage signals.

The embodiments of the present disclosure do not limit the specific internal structure of the first SST device 103.

In one embodiment, the internal structure of the first SST device 103 is the same as the internal structure of the first SST device 12 in the foregoing embodiments, and may specifically refer to the embodiments corresponding to FIG. 6, FIG. 7, and FIG. 8.

The embodiments of the present disclosure do not limit the specific internal structure of the first SST device 105.

In one embodiment, when the second SST device 105 includes one output end, the internal structure of the second SST device 105 is the same as the internal structure of the first SST device 12 in the foregoing embodiments, and may specifically refer to the embodiments corresponding to FIG. 6, FIG. 7, and FIG. 8.

In another embodiment, when the second SST device 105 includes two output ends, an internal structure of the second SST device 105 is the same as an internal structure of the second SST device 33 in the foregoing embodiments, and may specifically refer to the embodiment corresponding to FIG. 9.

It should be noted that the fact that the second SST device 105 includes one output end or two output ends is merely exemplary. As needed, the second SST device 105 may have f output ends, where f is an integer greater than or equal to 1. Correspondingly, when the second SST device 105 includes/fourth units, each fourth unit has one ACDC module and f DCDC modules. In each fourth unit, the input ends of the f DCDC modules are connected in parallel and then electrically connected to the output end of the ACDC module. The input end of the ACDC module forms the input end of the fourth unit, and the output ends of the f DCDC modules respectively form the first output end to the f-th output end of the fourth unit. The input ends of the t fourth units are connected in series to form the first input end 1051 of the second SST device 105, and the first output ends of the/fourth units are connected in parallel to form the first output end of the second SST device 105. Subsequently, the output ends with the same number in these/fourth units are connected in parallel successively to obtain the f output ends of the second SST device 105.

For example, the second output ends of the t fourth units are connected in parallel to form the second output end of the second SST device 105. For another example, the f-th output ends of the/fourth units are connected in parallel to form the f-th output end of the second SST device 105.

In the SST device, configuring multiple DCDC modules in one unit can facilitate the SST device to meet voltage and current requirements of different specifications. When multiple output ends are needed, this approach can avoid the use of multiple SST devices, thereby reducing costs. Moreover, since multiple output ends are integrated in one SST device, compared with adding one additional SST device to increase output ends, the overall SST device can have a smaller size, resulting in a smaller-volume electrolysis system. When the SST device has multiple units, the output current of the SST device can also be controlled by adjusting the number of parallel-connected units, thus meeting the requirements of the load (e.g., an electrolytic tank).

Other embodiments of the present disclosure will be readily apparent to those skilled in the art upon consideration of the specification and practice of the contents disclosed herein. The present application is intended to cover any variations, uses, or adaptive changes of the present disclosure, which follow the general principles of the present disclosure and include common knowledge or customary technical means in the art that are not disclosed in the present disclosure. The specification and the embodiments are to be regarded as exemplary only, and the true scope and spirit of the present disclosure are indicated by the appended claims.

What is claimed is:

1. An electrolysis system, comprising:
a first electrolytic cell; and
a first solid state transformer (SST) device, comprising a first input end and a first output end, wherein the first output end comprises a first positive output terminal and a first negative output terminal;
wherein the first positive output terminal of the first SST device is electrically connected to an electrolyte of the first electrolytic cell, and the first negative output terminal of the first SST device is electrically connected to the electrolyte of the first electrolytic cell.

2. The electrolysis system according to claim 1, wherein the first positive output terminal of the first SST device is electrically connected to a metal electrode of the first electrolytic cell, and the metal electrode is electrically connected to the electrolyte of the first electrolytic cell.

3. The electrolysis system according to claim 2, wherein the electrolysis system further comprises a second electrolytic cell, a third electrolytic cell, and a second SST device;
wherein the second SST device comprises a first input end, a first output end and a second output end, and the first output end of the second SST device comprises a first positive output terminal and a first negative output terminal; and
the second output end of the second SST device comprises a second positive output terminal and a second negative output terminal, wherein the first input end of the first SST device is connected in parallel with the first input end of the second SST device, the first positive output terminal of the second SST device is electrically connected to a metal electrode of the second electrolytic cell, the first negative output terminal of the second SST device is electrically connected to an electrolyte of the second electrolytic cell, the second positive output terminal of the second SST device is electrically connected to a metal electrode of the third electrolytic cell, and the second negative output terminal of the second SST device is electrically connected to an electrolyte of the third electrolytic cell.

4. The electrolysis system according to claim 3, wherein the first positive output terminal of the first SST device, the first positive output terminal of the second SST device, and the second positive output terminal of the second SST device are electrically connected, and the metal electrode of the second electrolytic cell, the metal electrode of the third electrolytic cell, and the metal electrode of the first electrolytic cell are electrically connected.

5. The electrolysis system according to claim 2, wherein the electrolysis system further comprises a fourth electrolytic cell, and the first SST device further comprises a second output end, wherein the second output end of the first SST device comprises a second positive output terminal and a second negative output terminal, the second positive output terminal of the first SST device is electrically connected to a metal electrode of the fourth electrolytic cell, and the second negative output terminal of the first SST device is electrically connected to an electrolyte of the fourth electrolytic cell.

6. The electrolysis system according to claim 5, wherein the first positive output terminal of the first SST device is electrically connected to the second positive output terminal of the first SST device, and the metal electrode of the first electrolytic cell is electrically connected to the metal electrode of the fourth electrolytic cell.

7. The electrolysis system according to claim 3, wherein a number of output ends of the first SST device is different from a number of output ends of the second SST device, and a number of an electrolytic cell electrically connected to the output ends of the first SST device is different from a number of electrolytic cells electrically connected to the output ends of the second SST device.

8. The electrolysis system according to claim 1, wherein the first electrolytic cell is a formation tank.

9. The electrolysis system according to claim 3, wherein the second electrolytic cell and the third electrolytic cell are formation tanks.

10. The electrolysis system according to claim 1, wherein the first input end of the first SST device is electrically connected to a medium-voltage alternating current (AC).

11. The electrolysis system according to claim 2, wherein the metal electrode of the first electrolytic cell comprises an extension portion or a power supply roller.

12. The electrolysis system according to claim 5, wherein the first output end and the second output end of the first SST device output different direct current (DC) voltage signals.

13. The electrolysis system according to claim 1, wherein the first SST device comprises m first units, and m is an integer greater than or equal to 1;
in a case that m is 1, the first unit comprises a first alternating current to direct current (ACDC) module and a first direct current to direct current (DCDC) module electrically connected with each other, an input end of the first ACDC module forms the first input end of the first SST device, and an output end of the first DCDC module forms the first output end of the first SST device; and
in a case that m is greater than 1, each of the first units comprises a second ACDC module and a second DCDC module, in each of the first units, the second ACDC module is electrically connected to the second DCDC module, input ends of m second ACDC modules are connected in series to form the first input end of the first SST device, and output ends of m second DCDC modules are connected in parallel to form the first output end of the first SST device.

14. The electrolysis system according to claim 1, wherein the first SST device comprises n second units, and n is an integer greater than or equal to 1;
in a case that n is 1, the second unit comprises a third ACDC module and k third DCDC modules, wherein k is an integer greater than 1, input ends of the k third DCDC modules are connected in parallel and then electrically connected to an output end of the third ACDC module, an input end of the third ACDC module forms the first input end of the first SST device, and output ends of the k third DCDC modules are connected in series to form the first output end of the first SST device; and
in a case that n is greater than 1, each of the second units comprises a fourth ACDC module and p fourth DCDC modules, wherein p is an integer greater than 1, in each of the second units, input ends of the p fourth DCDC modules are connected in parallel and then electrically connected to an output end of the fourth ACDC module, an input end of the fourth ACDC module forms an input end of the second unit, output ends of the p fourth DCDC modules are connected in series to form an output end of the second unit, the input ends of the n second units are connected in series to form the first input end of the first SST device, and the output ends of the n second units are connected in parallel to form the first output end of the first SST device.

15. The electrolysis system according to claim 1, wherein the first SST device comprises q third units, and q is an integer greater than or equal to 1;
in a case that q is 1, the third unit comprises a fifth ACDC module and r fifth DCDC modules, wherein r is an integer greater than 1, input ends of the r fifth DCDC modules are connected in parallel and then electrically connected to an output end of the fifth ACDC module, an input end of the fifth ACDC module forms the first input end of the first SST device, and output ends of the r fifth DCDC modules are connected in parallel to form the first output end of the first SST device; and
in a case that q is greater than 1, each of the third units comprises a sixth ACDC module and s sixth DCDC modules, wherein s is an integer greater than 1, in each of the third units, input ends of the s sixth DCDC modules are connected in parallel and then electrically connected to an output end of the sixth ACDC module, an input end of the sixth ACDC module forms an input end of the third unit, output ends of the s sixth DCDC modules are connected in parallel to form an output end of the third unit, the input ends of the q third units are connected in series to form the first input end of the first SST device, and the output ends of the q third units are connected in parallel to form the first output end of the first SST device.

16. The electrolysis system according to claim 3, wherein the second SST device comprises/fourth units, and/is an integer greater than or equal to 1;
in a case that/is 1, the fourth unit comprises a seventh ACDC module and two seventh DCDC modules, input ends of the two seventh DCDC modules are connected in parallel and then electrically connected to an output end of the seventh ACDC module, an input end of the seventh ACDC module forms the first input end of the second SST device, and output ends of the two seventh DCDC modules form the first output end and the second output end of the second SST device respectively; and
in a case that/is greater than 1, each of the fourth units comprises an eighth ACDC module and two eighth DCDC modules, in each of the fourth units, input ends of the two eighth DCDC modules are connected in parallel and then electrically connected to an output end of the eighth ACDC module, an input end of the eighth ACDC module forms an input end of the fourth unit, output ends of the two eighth DCDC modules form a first output end and a second output end of the fourth unit respectively, the input ends of the/fourth units are connected in series to form the first input end of the second SST device, the first output ends of the/fourth units are connected in parallel to form the first output end of the second SST device, and the second output ends of the/fourth units are connected in parallel to form the second output end of the second SST device.

17. An electrolysis system, comprising:
a first electrolytic cell, a second electrolytic cell; and
a first solid state transformer (SST) device, comprising a first input end and a first output end, wherein the first output end of the first SST device comprises a first positive output terminal and a first negative output terminal;
wherein the first positive output terminal of the first SST device is electrically connected to an electrolyte of the first electrolytic cell, the first negative output terminal of the first SST device is electrically connected to an electrolyte of the second electrolytic cell, and the first electrolytic cell is electrically connected to the second electrolytic cell.

18. The electrolysis system according to claim 17, wherein a manner in which the first electrolytic cell is electrically connected to the second electrolytic cell comprises:
a metal electrode of the first electrolytic cell being electrically connected to a metal electrode of the second electrolytic cell; or
the electrolyte of the first electrolytic cell and the electrolyte of the second electrolytic cell being intercommunicated through a pipeline.

19. The electrolysis system according to claim 17, further comprising a third electrolytic cell and a second SST device;
wherein the second SST device comprises a first input end and a first output end, the first input end of the first SST device is connected in parallel with the first input end of the second SST device, the first output end of the second SST device comprises a first positive output terminal and a first negative output terminal, the first positive output terminal of the second SST device is electrically connected to a metal electrode of the third electrolytic cell, and the first negative output terminal of the second SST device is electrically connected to an electrolyte of the third electrolytic cell.

20. The electrolysis system according to claim 19, wherein a number of output ends of the first SST device is different from a number of output ends of the second SST device, and a number of electrolytic cells electrically connected to the output ends of the first SST device is different from a number of an electrolytic cell electrically connected to the output ends of the second SST device.

21. The electrolysis system according to claim 17, wherein one of the first electrolytic cell and the second electrolytic cell is a power supply tank, and the other is a formation tank.

22. The electrolysis system according to claim 19, wherein the third electrolytic cell is a formation tank.

23. The electrolysis system according to claim 17, wherein the first input end of the first SST device is electrically connected to a medium-voltage alternating current (AC).

24. The electrolysis system according to claim 17, wherein the metal electrode of the first electrolytic cell and the metal electrode of the second electrolytic cell each comprise an extension portion or a power supply roller.

25. The electrolysis system according to claim 17, wherein the first SST device comprises m first units, and m is an integer greater than or equal to 1;
in a case that m is 1, the first unit comprises a first alternating current to direct current (ACDC) module and a first direct current to direct current (DCDC) module electrically connected with each other, an input end of the first ACDC module forms the first input end of the first SST device, and an output end of the first DCDC module forms the first output end of the first SST device; and
in a case that m is greater than 1, each of the first units comprises a second ACDC module and a second DCDC module, in each of the first units, the second ACDC module is electrically connected to the second DCDC module, input ends of m second ACDC modules are connected in series to form the first input end of the first SST device, and output ends of m second DCDC modules are connected in parallel to form the first output end of the first SST device.

26. The electrolysis system according to claim 17, wherein the first SST device comprises n second units, and n is an integer greater than or equal to 1;
in a case that n is 1, the second unit comprises a third ACDC module and k third DCDC modules, wherein k is an integer greater than 1, input ends of the k third DCDC modules are connected in parallel and then electrically connected to an output end of the third ACDC module, an input end of the third ACDC module forms the first input end of the first SST device, and output ends of the k third DCDC modules are connected in series to form the first output end of the first SST device; and
in a case that n is greater than 1, each of the second units comprises a fourth ACDC module and p fourth DCDC modules, wherein p is an integer greater than 1, in each of the second units, input ends of the p fourth DCDC modules are connected in parallel and then electrically connected to an output end of the fourth ACDC module, an input end of the fourth ACDC module forms an input end of the second unit, output ends of the p fourth DCDC modules are connected in series to form an output end of the second unit, the input ends of the n second units are connected in series to form the first input end of the first SST device, and the output ends of the n second units are connected in parallel to form the first output end of the first SST device.

27. The electrolysis system according to claim 17, wherein the first SST device comprises q third units, and q is an integer greater than or equal to 1;
in a case that q is 1, the third unit comprises a fifth ACDC module and r fifth DCDC modules, wherein r is an integer greater than 1, input ends of the r fifth DCDC modules are connected in parallel and then electrically connected to an output end of the fifth ACDC module, an input end of the fifth ACDC module forms the first input end of the first SST device, and output ends of the r fifth DCDC modules are connected in parallel to form the first output end of the first SST device; and
in a case that q is greater than 1, each of the third units comprises a sixth ACDC module and s sixth DCDC modules, wherein s is an integer greater than 1, in each of the third units, input ends of the s sixth DCDC modules are connected in parallel and then electrically connected to an output end of the sixth ACDC module, an input end of the sixth ACDC module forms an input end of the third unit, output ends of the s sixth DCDC modules are connected in parallel to form an output end of the third unit, the input ends of the q third units are connected in series to form the first input end of the first SST device, and the output ends of the q third units are connected in parallel to form the first output end of the first SST device.

28. The electrolysis system according to claim 19, wherein the second SST device comprises/fourth units, and/is an integer greater than or equal to 1;
in a case that/is 1, the fourth unit comprises a seventh ACDC module and two seventh DCDC modules, input ends of the two seventh DCDC modules are connected in parallel and then electrically connected to an output end of the seventh ACDC module, an input end of the seventh ACDC module forms the first input end of the second SST device, and output ends of the two seventh DCDC modules form the first output end and the second output end of the second SST device respectively;
in a case that/is greater than 1, each of the fourth units comprises an eighth ACDC module and two eighth DCDC modules, in each of the fourth units, input ends of the two eighth DCDC modules are connected in parallel and then electrically connected to an output end of the eighth ACDC module, an input end of the eighth ACDC module forms an input end of the fourth unit, output ends of the two eighth DCDC modules form a first output end and a second output end of the fourth unit respectively, the input ends of the/fourth units are connected in series to form the first input end of the second SST device, the first output ends of the/fourth units are connected in parallel to form the first output end of the second SST device, and the second output ends of the/fourth units are connected in parallel to form the second output end of the second SST device.
